(19) United States
(12) Patent Application Publication
(10) Pub. No.: US 2023/0387397 A1
(43) Pub. Date: Nov. 30, 2023

(54) COMPOSITE MATERIAL FOR LITHIUM SULFUR CELLS

(71) Applicant: GELION TECHNOLOGIES PTY LTD, Eveleigh New South Wales (AU)

(72) Inventor: Ben LLOYD, Abingdon, Oxfordshire (GB)

(21) Appl. No.: 18/031,674

(22) PCT Filed: Oct. 8, 2021
(86) PCT No.: PCT/GB2021/052612

§ 371 Date: Apr. 13, 2023

(30) Foreign Application Priority Data
Oct. 13, 2020 (GB) 2016256.6

(51) Int. Cl. H01M 4/38; H01M 4/62; H01M 4/04; H01M 4/40; H01M 10/0568; H01M 10/0569; H01M 10/0562

(52) U.S. Cl. CPC H01M 4/38; H01M 4/625; H01M 4/621; H01M 4/0471; H01M 4/405; H01M 10/0568; H01M 10/0569; H01M 10/0562; H01M 4/0428; H01M 2004/021

(57) ABSTRACT

The present invention relates to a carbon-sulfur composite material, namely coated particles of carbon-sulfur composite material. The present invention also relates to a cathode comprising said carbon-sulfur composite material, and an electrochemical cell comprising said cathode. The present invention further relates to a method of forming coated particles of carbon-sulfur composite material.

The present invention relates to a carbon-sulfur composite material, namely coated particles of carbon-sulfur composite material. The present invention also relates to a cathode comprising said carbon-sulfur composite material, and an electrochemical cell comprising said cathode. The present invention further relates to a method of forming coated particles of carbon-sulfur composite material.

### BACKGROUND

A typical lithium-sulfur cell comprises an anode (negative electrode) formed from lithium metal or a lithium metal alloy, and a cathode (positive electrode) formed from elemental sulfur or other electroactive sulfur material. The sulfur or other electroactive sulfur-containing material may be mixed with an electrically conductive material to improve its electrical conductivity. For example, carbon-sulfur composite particles may be included within a cathode.

Increasing the cycle life of a cell such as a lithium-sulfur cell is desirable. Factors that may affect cycle life include dissolution of the sulfur-based active material from composite carbon-sulfur particles into liquid electrolyte, which reduces the amount of available active material. Similarly, degradation of a liquid electrolyte may occur through contact with the active material.

Application of a coating layer onto a sulfur-based cathode using MLD is discussed in Nature Communications, Li et al, 9, Article number 4509 (2018). However, coating of the whole of the active material would not be achieved, as conformal coating of individual particles would not be possible due to the cathode structure and application method. Application of such a coating layer on a cathode can also give poor homogeneity of coating, due to masking or shadowing effects that may occur during coating application.

### DESCRIPTION

Before particular examples of the present invention are described, it is to be understood that the present disclosure is not limited to the particular cells, methods or materials disclosed herein. It is also to be understood that the terminology used herein is used for describing particular examples only and is not intended to be limiting, as the scope of protection will be defined by the claims and equivalents thereof.

In describing and claiming the cell and method of the present invention, the following terminology will be used: the singular forms “a”, “an” and “the” include plural forms unless the context clearly dictates otherwise. Thus, for example, “a cathode” includes reference to one or more of such elements.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

As used throughout the specification, the term “anode” refers to the negative electrode in an electrochemical cell, i.e. the electrode at which oxidation occurs during charge of the cell. As used throughout the specification, the term “cathode” refers to the positive electrode in an electrochemical cell, i.e. the electrode at which reduction occurs during charge of the cell.

In accordance with an aspect of the invention, there is provided a carbon-sulfur composite material comprising:
(i) composite particles comprising electrochemically active sulfur material and an electronically conductive carbon material; and
(ii) a layer comprising a ceramic, polymer or a ceramic-polymer hybrid material, or combinations thereof, wherein the layer covers the exterior surface of each of the particles.

In accordance with another aspect of the invention, there is provided a cathode comprising a carbon-sulfur composite material as disclosed herein.

In accordance with a further aspect of the invention, there is provided a lithium-sulfur cell comprising a cathode as disclosed herein, wherein the cell further comprises an anode formed from lithium metal and/or a lithium metal alloy and an electrolyte.

In the present invention, a coating is present on the composite sulfur-carbon particles. The present inventors have surprisingly found that the coated composite particles in accordance with the present invention can provide an increase in cycle life in a cell such as a lithium-sulfur cell. For example, the coating can minimise or prevent dissolution of sulfur-based active material from the composite sulfur-carbon particles into the electrolyte of such a cell. This may be particularly advantageous in a cell that, for example, is a hybrid liquid/solid state cell, such as those described in GB 2577114. In such a cell, reduction and oxidation reactions of the electroactive sulfur in the cathode occur with limited or no solubilisation of intermediate polysulfide species. This may be combined with use of a liquid electrolyte with a low solubility for polysulfide species. In such a cell, retaining the sulfur-based active material within the composite particles and its coating can improve cycle life.

The coating in accordance with the present invention can also minimise or prevent dissolution of additives such as ionically conductive ceramics or polymers that may also be present in the composite particles into the liquid electrolyte, if such additives are included within the composite particles. Similarly, the coating can also minimise or prevent degradation of a liquid electrolyte which can otherwise occur during contact with an active material. The coating can also be beneficial to the safety of the cell, as contact of polysulfides with moisture from the air can be prevented or minimised in the event of the cell rupturing during use. Additionally, methods of coating composite particles in accordance with the present invention, for example atomic layer deposition or molecular layer deposition, can enable a thin, homogeneous coating to be formed. This may obviate disadvantages associated with providing a coating on a cathode layer as a whole, for example poor homogeneity of the coating due to masking or shadowing effects occurring during the coating process, which may lead to accelerated degradation of the cathode, and loss of sulfur into an electrolyte. A coating applied to a cathode as a whole is also more easily damaged, for example in the case of cell rupture, than coating applied to individual composite particles.

### Composite

In accordance with the present invention, the cathode comprises a carbon-sulfur composite material. The carbon-sulfur composite material is formed of sulfur domains within the pores of a carbon host material. The cathode comprises greater than 60 wt. % sulfur, preferably greater than 65 wt. % sulfur, preferably greater than 70 wt. % sulfur, for example greater than 80 wt. % sulfur. For the avoidance of doubt, this total weight refers to the weight of the cathode inclusive of carbon-sulfur material, binder and other additives, but excludes the weight of a separate current collector where present. The structure of the carbon material, in particular the size of the pores within the carbon material and the total pore volume present is such that, when the pores of the carbon material are filled with sulfur, the sulfur content of the composite material is greater than 60 wt. % sulfur, preferably greater than 65 wt. % sulfur, preferably greater than 70 wt. % sulfur, more preferably greater than 75 wt. % sulfur, for example greater than 80 wt. % sulfur. Thus, the structure of the carbon host within the cathode can allow a cell containing a high proportion of active component mass to be formed.

The composite material includes at least one electronically conductive carbon material. Any suitable carbon material may be used. The electronically conductive carbon material may comprise carbon-based nanoparticles including carbon nanotubes, carbon nanofibres, nanographite and graphene. Examples of carbon materials that may be utilised include Ketjen Black, Carbon Super P, and Maxsorb-III. Combinations of electronically conductive carbon materials may be used. The carbon host structure advantageously has a specific pore structure and pore volume. Preferably, the carbon material has an average pore volume of at least 1.5 cm³ g⁻¹. Preferably, the carbon material has an average pore volume of 10 cm³ g⁻¹ or less. For example, the average pore volume of the carbon material is between 1.5 cm³ g⁻¹ and 10 cm³ g⁻¹. In one embodiment, the average pore volume of the carbon material is from 1.5-3 cm³ g⁻¹, preferably from 1.6-2.5 cm³ g⁻¹, for example from 1.7 to 2.0 cm³ g⁻¹. Exemplary carbon material Maxsorb-III (MSC-30) has an average pore volume of approximately 1.79 cm³ g⁻¹+/−0.2 (in other words, from about 1.59 to 1.99 cm³ g⁻¹).

In a preferred embodiment, the carbon material has an average pore diameter of less than 10 nm, preferably less than 5 nm, for example less than 3 nm. In one embodiment, the carbon material has an average pore diameter of between 1 to 3 nm, preferably between 1.5 to 2.5 nm, for example between 1.75 to 2.25 nm. With regard to the pore size distribution in Maxsorb-III, this is largely made up of pores with a diameter of between 1-3 nm.

In the carbon material in accordance with the present invention, the pore size distribution may be such that at least 45% of the pores in the carbon material have a diameter falling within the range of 1-10 nm, for example within the range of 1-3 nm. Preferably, at least 50% of the pores fall within the range of 1-10 nm, for example at least 60% of the pores fall within the range of 1-10 nm. For example, at least 50% of the pores fall within the range of 1-3 nm, for example at least 60% of the pores fall within the range of 1-3 nm. In accordance with a preferred embodiment of the invention, from 45 to 75% of the pores in the carbon material have a diameter of between 1-10 nm, for example 50 to 70% of the pores in the carbon material have a diameter of between 1-10 nm. For example, from 45 to 75% of the pores in the carbon material have a diameter of between 1-3 nm, for example 50 to 70% of the pores in the carbon material have a diameter of between 1-3 nm. The other pores in the carbon material may either be ultramicropores, micropores, mesopores, or a combination thereof. The carbon material in accordance with the present invention may comprise from 10-49% of pores having a diameter of less than 1 nm, for example from 20-40% pores having a diameter of less than 1 nm. Additionally or alternatively, the carbon host material may comprise from 1-30% pores having a diameter of greater than 3 nm, for example 5-20% of pores having a diameter of greater than 3 nm.

The carbon material may comprise ultramicropores, micropores, or mesopores, or a combination thereof. Pore dimensions (average diameter, and volume) may be measured by any suitable method, for example BET analysis (using nitrogen gas). In accordance with the IUPAC definition of a microporous material, this contains pores having a pore diameter of less than 2 nm, with a mesoporous material containing pores having a pore diameter of between 2 nm and 50 nm. An ultramicroporous material contains pores having a pore diameter of 1 nm or less. Any carbon material with a suitable pore structure may be contemplated, for example commercially available high surface area carbon materials such as Maxsorb-III (MSC-30). Alternatively, a carbon material having a suitable pore structure may be manufactured using any suitable method. Examples of such methods include templating or activation, where “templating” refers to a bottom-up method for manufacturing a carbon host material, and “activation” refers to a top-down method. In one example, a carbon host material may be produced via chemical activation of a carbon feedstock. In another example, a suitable carbon host material may be formed via pyrolysis of a carbon-containing precursor. Formation of the carbon material may either be self-templated e.g. pyrolysis of a MOF (metal organic framework) or involve the application of a structural template e.g. pyrolysis of a precursor material within zeolite template.

In another embodiment, the carbon material may be formed from carbon fibres. In this embodiment, the carbon fibres may have an average diameter of between 0.5 to 50 μm, preferably 5 to 30 μm, for example 10 to 20 μm. The length of such carbon fibres may be between 100 μm to 30 cm, preferably between 500 μm and 10 cm, for example between 1 mm and 1 cm. In this embodiment, the carbon material may take the form of a carbon fibre mat comprising at least one carbon fibre.

In a preferred embodiment, the electronically conductive carbon host material which forms the S/C composite material has an average pore volume of from 1.5-3 cm³ g⁻¹, for example from 1.5-2.0 cm³ g⁻¹, and an average pore diameter of from 1 nm to 10 nm, for example from 1 nm to 3 nm.

The composite material includes at least one electrochemically active sulfur material. The electrochemically active sulfur material may comprise elemental sulfur, sulfur-based organic compounds, sulfur-based inorganic compounds and sulfur-containing polymers, or combinations thereof. Preferably, elemental sulfur or an alkali metal sulfide such as Li₂S or Na₂S is used. Optionally, the particle size of the carbon host material is reduced prior to the introduction of sulfur. Any suitable method may be used, for example, impact of carbon particles each other and/or with other objects (such as balls, in ball milling; or bead milling) can reduce particle size. Suitable methods of particle size reduction include ball milling, bead milling, rotary drum milling, jet milling, or combinations thereof. In a preferred embodiment, bead milling is used. A further step of particle size selection may be performed. This particle size selection may be carried out by any suitable method. For example, particle size selection may be performed by sieving, or methods of separation by mass such as separation using a vortex. Size selection may result in carbon particles having a diameter of from 0.5 to 50 μm, preferably 5 to 30 μm, for example 10 to 20 μm. Reduction and/or selection of a particular particle size may enable preparation of a more homogeneous and/or dense electrode. Particle size selection may also be based on the desired performance of the resulting cell. For example, a bimodal distribution of particle size may be selected, or selection of a lower average particle size may be made.

Electrochemically active sulfur material is introduced into the carbon host material to form a carbon-sulfur composite material. The cathode starting materials may be combined by any suitable method. Preferably, the sulfur material infiltrates the carbon host structure, such that the sulfur material fills pores within the carbon host structure. Any suitable method of combining the carbon and sulfur materials that essentially retains the structure of the carbon host material may be used, for example ball milling, precipitation, or a melt infusion or diffusion process. In a preferred embodiment, melt infusion is used. For example, heating of the carbon and sulfur materials at a temperature of between 125-180° C., preferably 130-160° C. under a static vacuum may produce a carbon-sulfur composite material. Effective infiltration of the sulfur material into the carbon host enables a composite structure having a high proportion of sulfur to be obtained. In one embodiment, the sulfur material fills all the pores within the carbon host structure.

In one embodiment, the method further comprises grinding the carbon-sulfur composite material. This may result in a reduced particle size. In addition, mechanical grinding of the composite material can provide effective mixing of the carbon and sulfur materials, and may provide a high interface between the resulting particles. For example, impact of particles within the composite material with each other and/or with other objects (such as balls, in ball milling; or bead milling) can reduce particle size. Suitable methods include ball milling, bead milling, rotary drum milling or jet milling, or combinations thereof. In a preferred embodiment, bead milling is used. Without wishing to be bound by theory, it is believed that methods such as ball milling, melt infusion, bead milling, co-extrusion or jet milling may result in a cathode having a high sulfur/carbon interface. The cathode materials may additionally be mixed by a simple mixing process before any of the methods above are employed.

Bead milling is performed in a milling chamber in which grinding beads grind the cathode materials to provide a reduced particle size. Bead milling may be performed on dry cathode materials, or optionally wet grinding may be performed if a solvent is also present. Ball milling is performed in a ball mill. In a ball milling, the ball mill is rotated such that balls (made of, for example, steel, titanium, agate, ceramic or rubber) inside the mill impact with the cathode materials. Jet milling is performed in a jet mill. A jet mill grinds and mixes the cathode materials by using a jet of compressed air or inert gas to impact the materials into each other. Milling can be performed over a time period of between 1 minute to 48 hours, preferably 10 minutes to 24 h, more preferably 25 minutes to 10 hours, for example 25 min to 4 h. The speed of rotation of the ball mill can range from 50 rpm to 1,000 rpm, preferably 250 to 750 rpm, for example 350 to 500 rpm. An example of a suitable ball mill is a Fritsch ‘Pulverisette 6’ planetary mon mill.

In one embodiment, the composite material is formed by melt infusion of sulfur into an activated carbon. In an example, the activated carbon is produced via a thermal KOH activation process, in which a KOH to carbon source ratio of between 2:1-20:1 is preferably used and the temperature of the thermal activation step is conducted between 500-1000° C.

Following the processes detailed above, the particle size may be reduced. Final particle size may be within the range of up to 50 μm, preferably up to 30 μm, for example up to 10 μm. For example, particle sizes may fall within the range of 0.1 μm to 50 μm, preferably 5 μm to 40 μm, for example 15 μm to 30 μm. By particle size, it is meant the maximum length of the particle in any direction. For example, the particle diameter may be within the range of up to 10 μm, preferably up to 5 μm, for example up to 3 μm. This particle size selection may be carried out by any suitable method. For example, particle size selection may be performed by sieving, or methods of separation by mass such as separation using a vortex.

An optional step to remove excess sulfur may be conducted. This may involve sublimation, thermal treatment (optionally under vacuum) or washing in a solvent with high sulfur solubility (for example, CS₂). Removal of excess sulfur may additionally or alternatively be conducted following preparation of the carbon-sulfur composite.

Following the processes detailed above, additional electronically conductive additives, for example, electronically conductive carbon such as carbon black or carbon nanotubes, and/or other ionically conductive additives such as LGPS may be added to the electrochemically active sulfur/carbon mixture. Further mixing may take place to evenly distribute the additives throughout the mixture. Alternatively, additives may be combined with the carbon host material in advance of or during sulfur infiltration.

In one embodiment, the carbon-sulfur composite material further comprises additives such as ionically conductive ceramics or polymers. Such additives may take the form of a solid electrolyte material. The additives such as ionically conductive ceramics or polymers may be present in an amount of from 0.1 to 50 wt % of the composite material, i.e. of the carbon-sulfur composite and additives. Any suitable additives may be included. For example, additives selected from ionically conductive ceramics may be included. Suitable ceramic materials may include, but are not limited to, oxides, carbonates, nitrides, carbides, sulfides, oxysulfides, and/or oxynitrides of metals and/or metalloids. Non-limiting examples of suitable solid-state electrolytes of sufficient ionic conductivity may be produced by a combination of various lithium compounds, such as ceramic materials including lithium include lithium oxides (e.g., Li₂O, LiO, LiO₂, LiRO₂, where R is scandium, yttrium, lanthanum, cerium, praseodymium, neodymium, promethium, samarium, europium, gadolinium, terbium, dysprosium, holmium, erbium, thulium, ytterbium, and/or lutetium), lithium carbonate (Li₂CO₃), lithium nitrides (e.g., Li₃N), lithium oxysulfide, lithium oxynitride, lithium garnet-type oxides (e.g., Li₇La₃Zr₂O₁₂), Li₁₀GeP₂S₁₂, lithium phosphorus oxynitride, lithium silicosulfide, lithium germanosulfide, lithium lanthanum oxides, lithium titanium oxides, lithium borosulfide, lithium aluminosulfide, lithium phosphosulfide, lithium silicate, lithium borate, lithium aluminate, lithium phosphate, lithium halides, and combinations of the above. In certain cases, the ceramic material comprises a lithium oxide, a lithium nitride, or a lithium oxysulfide. In some embodiments, the ceramic includes a carbonate and/or a carbide. Examples of solid electrolyte materials include LiPON (lithium phosphorus oxynitride), LLZO (lithium lanthanum zirconium oxide), LATP (lithium aluminium titanium phosphate), LGPS (L₁₀GeP₂P₂S₁₂, LPS (lithium phosphorus sulfide) and LAGP (lithium aluminium germanium phosphate) and combinations thereof.

In some embodiments, the ionically conductive material may be selected from species that can donate electron pairs (e.g. a Lewis base). Examples of suitable electron-donating materials include, but are not limited to, lithium oxides (e.g., Li₂O, LiO LiO₂, LiRO₂, where R is scandium, yttrium, lanthanum, cerium, praseodymium, neodymium, promethium, samarium, europium, gadolinium, terbium, dysprosium, holmium, erbium, thulium, ytterbium, and/or lutetium), lithium carbonate (Li₂CO₃), lithium nitrides (e.g., Li₃N), lithium oxysulfide, lithium oxynitride, lithium garnet-type oxides (e.g., Li₇La₃Zr₂O₁₂), Li₁₀GeP₂S₁₂, lithium phosphorus oxynitride, lithium silicosulfide, lithium germanosulfide, lithium lanthanum oxides, lithium titanium oxides, lithium borosulfide, lithium aluminosulfide, lithium phosphosulfide, lithium silicate, lithium borate, lithium aluminate, lithium phosphate, lithium halides, and combinations of the above.

Examples of ceramic materials that can be used as the lithium-ion conductive material include: Li-containing oxides e.g. Li_{3.3}La_{0.56}TiO₃; Nasicon-type structure (Na₁₊ₓZr₂SiₓP₃₋ₓO₁₂, 0<x<3); LiTi(PO₄)₃; LiSICON (Li₁₄Zn(GeO₄)₄); Li₁₀GeP₂S₁₂; Garnet: Li₇La₃Zr₂O₁₂; Li₂O; other oxides e.g. Al2O3, TiO2, ZrO2 SiO2, ZnO; sulfides e.g. Li₂S—P₂S₅; antiperovskites e.g. Li₃OCl; hydrides e.g. LiBH₄, LiBH₄—LiX (X=Cl, Br, I), LiNH, LiNH₂, Li₃AlH₆, Li₂NH; borates or phosphates e.g. Li₂B₄O₇, Li₃PO₄, LiPON; carbonates or hydroxides e.g. Li₂CO₃, LiOH; fluorides, e.g. LiF; nitrides e.g. Li3N; sulfides e.g. lithium borosulfides, lithium phosphosulfides, lithium aluminosulfides, oxysulfides, praseodymium oxide. At least one of said ceramic materials may be used, or combinations thereof. In a sodium sulfur cell, the sodium ion equivalent of any of these conductive materials may be utilised.

Additionally or alternatively, additives including a polymeric material which is inherently ionically conductive may be included. Polymers blended with lithium salts, which can achieve bulk conductivities of greater than 10⁻⁷ S/cm, may also be used. Examples of suitable polymers include EO based polymers (for example PEO); acrylate based polymer (for example PMMA); polyamines (polyethyleneimine); siloxanes (poly(dimethylsiloxane)); polyheteroaromatic compounds (e.g., polybenzimidazole); polyamides (e.g. Nylons), polyimides (e.g. Kapton); polyvinyls (e.g. polyacrylamide, poly(2-vinyl pyridine), poly(N-vinylpyrrolidone), poly(methylcyanoacrylate), poly(vinyl acetate), poly (vinyl alcohol), poly(vinyl chloride), poly(vinyl fluoride); inorganic polymers (e.g. polysilane, polysilazane. polyphosphazene, polyphosphonate); polyurethanes; polyolefins (e.g. polypropylene, polytetrafluoroethylene); polyesters (e.g. polycarbonate, polybutylene terephthalate). In one embodiment, co-block polymers such as Nafion may be used. At least one of said polymeric materials may be used, or combinations thereof.

In one embodiment, the cathode contains one or more ceramic materials in combination with one or more ionically conductive polymers.

Where ionically conductive ceramics or polymers are present in the composite material, these may be present in an amount of less than 50 wt %, for example less than 25 wt %, for example less than 10 wt % of the total weight of the composite material. The ionically conductive ceramics or polymers may be present in an amount of greater than 1 wt %, for example greater than 5 wt % of the total weight of the composite material.

Additionally, the composite material may have other additives, for example lithium ion conducting additives. In one embodiment, the composite material contains additional sulfur-containing materials (aside from the electroactive sulfur), wherein said materials contain sulfur as well as additional elements such as Li, Na, Mg, P, N, Si, Ge, Ti, Zr, Sn, B, Al, Fe, Ni, Co, Cl, Br, I, O or any combination thereof. Examples of sulfur-containing materials include LGPS, Li₃PS₄, and Li₇P₃S₁₁. Where additional sulfur-containing materials are included in the composite material, these may be present in an amount of less than less than 50 wt %, for example less than 25 wt %, for example less than 10 wt % of the total weight of the composite material. Where additional sulfur-containing materials are included in the composite material, these may be present in an amount of greater than 1 wt %, for example greater than 5 wt % of the total weight of the composite material.

### Coating

In accordance with the present invention, the composite particles described above include a coating layer. This coating layer may be applied using any suitable method, for example atomic layer deposition or molecular layer deposition. The present inventors have surprisingly found that a coating as described herein can provide a number of advantages to a cell, for example a lithium sulfur cell. In particular, the present inventors have found that coating of individual composite particles may be beneficial in the context of a cathode within an electrochemical cell, for example may be beneficial to cycle life and cell safety. For example, the coating in accordance with the present invention may improve capacity retention and cycle life of a cell. This improvement may be obtained by minimising or preventing dissolution of active material such as elemental sulfur, lithium polysulfides and lithium sulfide into a liquid electrolyte. Where active material is in contact with a liquid electrolyte, sulfur may be dissolved into the electrolyte which may cause a loss of capacity in the cell. This may be particularly beneficial at higher temperatures, for example at temperatures above 40° C., at which dissolution of active material into the electrolyte may otherwise be accelerated.

In addition, the coating layer may also be advantageous to reduce or minimise contact between a liquid electrolyte and active material. Consequently, chemical decomposition of the liquid electrolyte as a result of contact with the active material may also be reduced. For example, where a liquid electrolyte comprising LiFSI is present in a cell, reaction of LiFSI with the polysulfides may be minimised. As a further example, solvents such as carbonates may be used in the electrolyte. Whilst carbonate solvents may react with polysulfides during cycling, particularly at high sulfur loadings, coating the composite particles as described herein may avoid or reduce contact between the carbonate and polysulfides, thus minimising such unwanted reactions. This can allow the use of carbonate electrolytes within a cell such as a lithium-sulfur cell.

The coating layer may comprise any suitable material. Preferably, the coating layer is impermeable or substantially impermeable to the active material, for example to elemental sulfur, lithium polysulfide and lithium sulfide. The coating layer may also be impermeable or substantially impermeable to liquid electrolyte. The coating layer can allow conduction of lithium cations to and from the active material during cell cycling, i.e. have a high lithium ion conductivity. The lithium ion conductivity of the layer may be greater than 10⁻¹⁰ S cm⁻¹ at 25° C., for example greater than 10⁻⁸ S cm⁻¹ at 25° C., for example greater than 10⁻⁷ S cm⁻¹, at 25° C. Preferably, the layer is a thin layer; for example the layer may have a thickness of less than 100 nm, for example less than 75 nm, for example less than 50 nm, for example less than 25 nm. With regard to the area specific lithium ionic resistance of the coating, this may be derived from the product of the thickness and lithium ion conductivity of the layer. For example, the area specific resistance of the layer may be less than 10 Ωcm².

The coating layer may comprise a ceramic, polymer, a ceramic-polymer hybrid material or combinations thereof.

In one embodiment, the coating layer comprises at least one ceramic material. Examples of suitable ceramic materials include oxide ceramics, non-oxide ceramics such as ceramic hydride, carbide, nitride, silicide, fluoride, sulfide and combinations thereof. Examples of oxide ceramics include aluminium oxide, cobalt oxide, gallium oxide, hafnium oxide, indium oxide, molybdenum oxide, niobium oxide, nickel oxide, tin oxide, tantalum oxide, tungsten oxide, titanium oxide, silicon oxide, vanadium oxide, zinc oxide, magnesium oxide, zirconium oxide, boron oxide and yttrium oxide. In one embodiment, the oxide is a metal oxide. Examples of nitrides include silicon nitride, aluminium nitride, gallium nitride, hafnium nitride, tantalum nitride, titanium nitride, tungsten nitride, and boron nitride. In one embodiment, the nitride is a metal nitride. Examples of carbides include titanium carbide, zirconium carbide, and vanadium carbide. In one embodiment, the carbide is a metal carbide. Examples of phosphides include boron phosphide, nickel phosphide and aluminium phosphide. In one embodiment, the phosphide is a metal phosphide. Examples of fluorides include magnesium fluoride and aluminium fluoride. In one embodiment, the fluoride is a metal fluoride. Examples of sulfides include molybdenum sulfide. In one embodiment, the sulfide is a metal sulfide.

In a preferred embodiment, the ceramic is selected from aluminium oxide, titanium oxide, silicon oxide, vanadium oxide, zinc oxide, magnesium oxide, zirconium oxide, boron oxide, yttrium oxide, silicon nitride, aluminium nitride, boron nitride, and combinations thereof. In accordance with an embodiment of the invention, the ceramic coating is formed using atomic layer deposition or molecular layer deposition.

In another embodiment, the coating comprises at least one hybrid coating material. The coating may comprise a hybrid organic-inorganic material, for example a ceramic-polymer hybrid material. In accordance with an embodiment of the invention, the hybrid coating material is formed using atomic layer deposition or molecular layer deposition. Examples of ceramic-polymer hybrid materials include metalcones such as alucone, titanicone, zircone and zincone. In one embodiment, a combination of ceramic-polymer hybrid materials may be used.

In another embodiment, the coating comprises a polymer material. Any suitable polymer coating material may be used. The polymer may comprise at least one functional group selected from the list of amine, amide, carbonyl, carboxyl, ether, thioether and hydroxyl groups, and mixtures thereof. Non-limiting examples of polymers include polyanhydrides, polyketones, polyesters, polystryenes, polyamides, polyimides, polyurethanes, polyolefins, polyvinylenes. Non-limiting examples of ionically conductive polymers may include nitrogen or sulfur containing polymers, for example polycarbazoles, polyindoles, polyazepines, polyanilines, polythiophenes, PPS. Further examples of ionically conductive polymers may include poly(fluorene)s, polyphenylenes, polypyrenes, polyazulenes, polynaphthalenes, poly(acetylene)s (PAC) and poly(p-phenylene vinylene) (PPV). In a preferred embodiment, the polymer material is polyethylene oxide.

Any combinations of the above coating materials may be envisaged. For example, the coating layer may comprise a mixture of a metal oxide and a metalcone. The combination of a metal oxide such as aluminium oxide with alucone may provide a number of advantages. For example, lower temperature deposition may be possible with ALD, for example in the application of a metal oxide such as aluminium oxide, and this may be combined with increased coating flexibility that may be provided by alucone, which may be applied using MLD. Thus, the combination of materials within the coating layer, and/or the combination of application methods, may be advantageous.

In one embodiment, the composite particles may be coated by a single coating layer, i.e. a single phase of coating material, wherein the coating material is selected from those listed above. Alternatively, the coating may be formed of a plurality of layers of different coating materials, i.e more than one coating material is present in the coating layer. The coating layer may cover the entire surface area of each of the composite particles, or may coat substantially the entire surface area of each of the composite particles. For example, the coating layer may coat at least 90% of the surface area of each of composite particles on average, for example at least 95%, for example at least 99%.

The coating layer may be applied using any suitable method. For example, the coating layer may be applied using atomic layer deposition, molecular layer deposition, chemical vapour deposition, plasma-enhanced chemical vapour deposition, sol gel coating, hydrothermal precipitation, solvothermal precipitation, or a combination thereof. In a preferred embodiment, the method comprises atomic layer deposition or molecular layer deposition. For example, atomic layer deposition may be used to form a ceramic coating layer. In another example, molecular layer deposition may be used to form a ceramic-polymer hybrid material.

Application of the coating layer may involve a number of steps that are repeated as many times as necessary to achieve the required deposited thickness. For example, in atomic layer deposition or molecular layer deposition, the method of applying the coating layer may involve (optionally) activating the surface of the particles to be coated, for example by using a plasma treatment; introduction of a first precursor; removal of excess first precursor (by purging the system); introduction of a second precursor; removal of excess second precursor (by purging the system); and repeating the process to build up layers of material; wherein the layers of coating material comprise the reaction products of the first and second precursors. Optionally, further precursors may be involved in the process, for example a third precursor. In an example, an AlOₓ coating layer may be formed by ALD using trimethylaluminum (TMA) and water as precursors. In another example, an alucone coating layer may be formed by MLD using trimethylaluminum (TMA), ethylene glycol (EG) and water as precursors. In another embodiment, a coating layer comprising both AlOₓ and alucone may be formed using a combination of ALD and MLD.

Any suitable temperature or pressure may be used for application of the coating layer. Preferably, the coating process is performed below 250° C.

In a preferred embodiment, a carbon-sulfur composite comprising carbon having an average pore volume of 1.5-3 cm³/g and an average pore diameter of less than 3 nm are used in the method in accordance with the present invention. Carbon having an average pore volume and average pore diameter as defined above, for example Maxsorb Ill, may be beneficial in terms of trapping sulfur within the pore structure. This can ensure a high sulfur content, for example greater than 65 wt %, within the coated particles. This may be particularly advantageous when coating is performed at relatively high temperature, for example above 100° C., as the sublimation temperature of sulfur can result in a low sulfur content in the coated composite particles. Thus, trapping of sulfur within the carbon structure can ensure a high sulfur content.

In accordance with the present invention, the method allows the formation of a thin layer of the surface of the composite particles. For example, the layer may have a thickness of less than 100 nm, for example less than 75 nm, for example less than 50 nm, for example less than 25 nm. The use of such methods also allows a conformal and homogeneous coating to be formed, while reducing or preventing the presence of holes (pin-holes) in the layer. Thus, provision of a thin layer formed as described herein may be advantageous in terms of providing the cathode with a high proportion of active component mass. Ensuring that the entirety of, or a high percentage of, the surface of each of the particles is coated can maximise the benefits of the coating layer, for example by minimising dissolution of active material from the sulfur-carbon composite particles into the liquid electrolyte. In addition, degradation of the liquid electrolyte that may occur through contact with the cathode active material may also be kept to a minimum.

Further to the above, the coating layer can also improve the safety of a cell, for example if the cell ruptures during use. In the absence of a coating, contact of polysulfides with water, for example from the air, can lead to the formation of toxic H₂S and/or SO₂. Coating of the composite particles would isolate the polysulfides and minimise contact between the polysulfides and the air, avoiding the formation of H₂S and/or SO₂. The coating can also minimise or prevent dissolution of sulfur-based active material or other additives from the composite particles during cathode and cell manufacture, for example during a slurry coating process or an extrusion process. This may allow the use of solvents that would otherwise react with either the active material or other additives during slurry coating, for example water, which could allow a slurry coating process to be performed in a cheap and environmentally friendly manner. Alternatively the coating may allow for processing of the composite particles in an environment which would otherwise react and degrade the active material components.

### Cathode

In accordance with an aspect of the present invention, there is provided a cathode comprising the composite particles described above. The cathode may also include a further, electronically conductive, carbon. Examples of electronically conductive carbon materials include carbon black, Ketjen black, Carbon Super P, graphene oxides or carbon nanotubes, or combinations thereof.

Following combination of the cathode starting materials and coating of the composite particles, the mixture may be processed via any suitable process to result in a suitable cathode e.g. mixed with solvent (e.g. water or organic solvent) and optional binder to form a slurry. Any suitable solvent may be selected, provided that the solvent does not solubilise nor chemically react with the active material, so as to ensure that the carbon-sulfur material structure and purity is maintained. For example, where the active sulfur material is elemental sulfur, a water-based slurry may be formed. In another example, where the active sulfur material is Li₂S, a non-aqueous slurry may be provided, for example an apolar solvent such as hexane. Any suitable binder may be used. Exemplary binders include PEO, PEI, PvDF-HFP, polyacrylates, polyacrylic acid, gelatin, carboxymethyl cellulose, alginates, alginic acid, and mixtures thereof. Alternatively, the binder may be added to the carbon host material before sulfur infiltration. Other additives may be added to the slurry to stabilise the slurry or adjust the pH. Such additives include pH buffers, ionic or non-ionic surfactants, or clay type surfactants.

The slurry is applied to a current collector and then dried to remove the solvent. Alternatively, coating may be performed via a dry process (e.g. via extrusion). Optionally, pressing or calendaring steps may be employed. The resulting structure may then be cut into the desired shape to form a cathode. The thickness of the resulting cathode may be in the range of 1 to 100 μm, preferably 15 to 80 μm, for example 20 to 50 μm.

### Electrolyte

Following production of the cathode, the cathode is placed into contact with an electrolyte. Any suitable solvent system or liquid or gel or mixture of liquids and/or gels may be used for the electrolyte. Preferably, the electrolyte is a liquid electrolyte, for example the electrolyte is liquid across the range of operating temperatures of the cell, which may be from −30 to 120° C., preferably from −10 to 90° C., for example from 0 to 60° C. Operating pressures of the cell may be from 5 mbar to 100 bar, preferably from 10 mbar to 50 bar, for example 100 mbar to 20 bar. In one example, the cell may be operated at room temperature and pressure.

Suitable organic solvents for use in the electrolyte are ethers (e.g. linear ethers, diethyl ether (DEE), diglyme (2-methoxyethyl ether), tetraglyme, tetrahydrofuran, 2-methyltetrahydrofuran, dimethoxyethane (DME), dioxolane (DIOX)); carbonates (e.g. dimethylcarbonate, diethylcarbonate, ethylmethylcarbonate, methylpropylcarbonate, ethylene carbonate (EC), propylene carbonate (PC); sulfones (e.g. dimethyl sulfone (DMS), ethyl methyl sulfone (EMS), tetramethyl sulfone (TMS)); esters (e.g. methyl formate, ethyl formate, methyl propionate, methylpropylpropionate, ethylpropylpropionate, ethyl acetate and methyl butyrate); ketones (e.g. methyl ethyl ketone); nitriles (e.g. acetonitrile, proprionitrile, isobutyronitrile); amides (e.g. dimethylformamide, dimethylacetamide, hexamethyl phosphoamide, N, N, N, N-tetraethyl sulfamide); lactams/lactones (e.g. N-methyl-2-pyrrolidone, butyrolactone); ureas (e.g. tetramethylurea); sulfoxides (e.g. dimethyl sulfoxide); phosphates (e.g. trimethyl phosphate, triethyl phosphate, tributyl phosphate); phosphoramides (e.g. hexamethylphosphoramide). Further suitable solvents include toluene, benzene, heptane, xylene, dichloromethane, and pyridine. In one embodiment, the electrolyte is a carbonate electrolyte, for example fluoroethylene carbonate (FEC), vinylene carbonate (VC), dimethyl carbonate (DMC), or ethylene carbonate (EC).

Any of the ethers, carbonates, sulfones, esters, ketones, nitriles, amides, lactams, ureas, phosphates, phosphoramides may be halogenated or partially halogenated. For example, any of the solvents detailed above may be fluorinated or partially fluorinated. An example of a fluorinated ether is 1,1,2,2,-tetrafluoroethyl-2,2,3,3-tetrafluoropropyl ether.

Any combination of one or more of the above solvents may be included in the electrolyte.

In an alternative embodiment, the electrolyte may comprise one or more ionic liquids as solvent. Said ionic liquids may comprise salts comprising organic cations such as imidazolium, ammonium, pyrrolidinium, and/or organic anions such as bis(trifluoromethanesulfonyl)imide TFSI⁻, bis(fluorosulfonyl)imide FSI⁻, triflate, tetrafluoroborate BF₄⁻, dicyanamide DCA⁻, chloride Cl⁻. The ionic liquid is liquid at room temperature (20° C.). Examples of suitable ionic liquids include (N,N-diethyl-N-methyl-N(2methoxyethyl)ammonium bis(trifluoromethanesulfonyl), N,N-Diethyl-N-methyl-N-propylammonium bis(fluorosulfonyl)imide, N,N-Diethyl-N-methyl-N-propylammonium bis(fluorosulfonyl)imide, N,N-dimethyl-N-ethyl-N-(3-methoxypropyl)ammonium bis(fluorosulfonyl)imide, N,N-dimethyl-N-ethyl-N-(3-methoxypropyl)ammonium bis(trifluoromethanesulfonyl)imide, N,N-Dimethyl-N-ethyl-N-benzylAmmonium bis(trifluoromethanesulfonyl)imide, N,N-Dimethyl-N-Ethyl-N-Phenylethylammonium bis(trifluoromethanesulfonyl)imide, N-Ethyl-N,N-dimethyl-N-(2-methoxyethyl)ammonium bis(fluorosulfonyl)imide, N-Ethyl-N,N-dimethyl-N-(2-methoxyethyl)ammonium bis(trifluoromethanesulfonyl)imide, N-Tributyl-N-methylammonium bis(trifluoromethanesulfonyl)imide, N-Tributyl-N-methylammonium dicyanamide, N-Tributyl-N-methylammonium iodide, N-Trimethyl-N-butylammonium bis(trifluoromethanesulfonyl)imide, N-Trimethyl-N-butylammonium bromide, N-Trimethyl-N-hexylammonium bis(trifluoromethanesulfonyl)imide, N-Trimethyl-N-propylammonium bis(fluorosulfonyl)imide, N-Trimethyl-N-propylammonium bis(trifluoromethanesulfonyl)imide, (N,N-diethyl-N-methyl-N(2methoxyethyl)ammonium bis(fluorosulfonyl)imide, 1-Butyl-1-methylpyrrolidinium bis(fluorosulfonyl)imide, 1-Ethyl-3-methylimidazolium bis(fluorosulfonyl)imide, 1-Methyl-1-(2-methoxyethyl)pyrrolidinium bis(fluorosulfonyl)imide, N,N-Diethyl-N-methyl-N-propylammonium bis(fluorosulfonyl)imide, N-Ethyl-N,N-dimethyl-N-(2-methoxyethyl)ammonium bis(fluorosulfonyl)imide, N-propyl-N-methylpiperidinium bis(fluorosulfonyl)imide, N-Trimethyl-N-butylammonium bis(fluorosulfonyl)imide, N-methyl-N-butyl-piperidinium bis(trifluoromethanesulfonyl)imide, N-methyl-N-propylpyrrolidinium bis(trifluoromethanesulfonyl)imide and combinations thereof.

Alternatively or additionally, the liquid electrolyte may be a gel electrolyte. The gel electrolyte may comprise polyethylene oxide with a gelling liquid electrolyte, for example an ether such as dimethyl ether. In one example, the electrolyte may comprise polyethylene oxide in combination with LiTFSI in dimethylether.

Any combination of the above solvents may be employed in the electrolyte. For example, the electrolyte may comprise the combination of an ionic liquid with a fluorinated ether, or the combination of an ionic liquid within a gel, or the combination of a fluorinated ether within a gel. Any other combination of two or more of the liquids and/or gels detailed above may be envisaged.

Suitable alkali metal salts for inclusion in the electrolyte include lithium or sodium salts. Suitable lithium salts include lithium hexafluorophosphate, lithium hexafluoroarsenate, lithium nitrate, lithium perchlorate, lithium trifluoromethanesulfonimide, lithium bis(trifluoromethanesulfonyl)imide, lithium bis(fluorosulfonyl)imide (LiSFI), lithium bis(oxalate) borate and lithium trifluoromethanesulphonate. Suitable sodium salts include sodium hexafluorophosphate, sodium hexafluoroarsenate, sodium nitrate, sodium perchlorate, sodium trifluoromethanesulfonimide, sodium bis(trifluoromethanesulfonyl)imide, sodium bis(fluorosulfonyl)imide, sodium bis(oxalate) borate and sodium trifluoromethanesulphonate. Preferably the lithium salt is lithium trifluoromethanesulphonate (also known as lithium triflate). Combinations of salts may be employed. For example, lithium triflate may be used in combination with lithium nitrate.

The lithium salt may be present in the electrolyte at a concentration of 0.1 to 6 M, preferably, 0.5 to 4 M, for example, 3 to 3.5 M. In a preferred embodiment the salt may be selected from LITFSI. The concentration of the at least one lithium or sodium salt in the solvent may be at least 75% of the saturation concentration of the solvent system, preferably at least 80% of the saturation concentration of the solvent, for example at least 85% of the saturation concentration of the solvent, for example at least 90% of the saturation concentration of the solvent. In one example, the concentration of the solvent is about 100% of the saturation concentration, i.e. the electrolyte may be fully saturated. The concentration of the at least one lithium or sodium salt in the solvent may be at least 75% of the saturation concentration of the solvent system, preferably at least 80% of the saturation concentration of the solvent, for example at least 85% of the saturation concentration of the solvent, for example at least 90% of the saturation concentration of the solvent. In one example, the concentration of the solvent is about 100% of the saturation concentration, i.e. the electrolyte may be fully saturated.

In an alternative embodiment, the lithium-sulfur cell may be an all-solid-state cell. In this embodiment, the electrolyte is a solid electrolyte. The solid electrolyte may be either crystalline or amorphous. Examples of solid electrolytes include ionically conductive ceramics, which may include, but are not limited to, oxides, carbonates, nitrides, carbides, sulfides, oxysulfides, and/or oxynitrides of metals and/or metalloids. In one embodiment, the electrolyte is a sulfide solid electrolyte comprising any of Li, S, P, Cl, F, I or Br. Examples of ionically conductive ceramics are detailed herein in the paragraphs relating to additives included in the carbon-sulfur composite material. The solid electrolyte may additionally or alternatively comprise polymeric material which is inherently ionically conductive may be included. Polymers blended with lithium salts, which can achieve bulk conductivities of greater than 10⁻⁷ S/cm, may also be used. Examples of suitable polymers are detailed herein in the paragraphs relating to additives included in the carbon-sulfur composite material.

### Anode

Any suitable anode may be employed in the cell in accordance with the present invention. Preferably, the anode may comprise an alkali metal, in particular lithium or sodium. In a lithium-sulfur cell, the lithium anode comprises an electrochemically active substrate comprising lithium. The electrochemically active substrate may comprise a lithium metal or lithium metal alloy. Preferably, the electrochemically active substrate comprises a foil formed of lithium metal or lithium metal alloy. Examples of lithium alloys include lithium aluminium alloy, lithium magnesium alloy and lithium boron alloy. Preferably, a lithium metal foil is used.

Where the cell is a sodium-sulfur cell, the anode comprises a sodium metal or sodium metal alloy. Preferably, the anode comprises a foil formed of sodium metal or sodium metal alloy. Examples of sodium alloys include sodium aluminium alloy, sodium magnesium alloy and sodium boron alloy. Preferably, a sodium metal foil is used. As an alternative, the anode may comprise an alternative material such as silicon or carbon, for example a silicon-containing composite such as a carbon-silicon composite, or for example graphite. In one embodiment, the electrode may be lithiated or sodiated, either prior to electrode formation, or prior to cell build. In another embodiment, the anode may take the form of a current collector comprising an electronically conducting substrate, an electrically conductive metallic foil, sheet or mesh. A current collector may typically be composed of a metallic conductor that is substantially inert, i.e. the metallic conductor does not participate in reduction or oxidation reactions during cycling of the cell. For example, the current collector may not be formed of an alkali metal such as lithium or sodium. Examples of suitable metals for formation of the current collector include inert metals such as aluminium, copper, nickel, titanium or tungsten. In a preferred example, the current collector comprises copper or nickel, for example copper or nickel foil. The current collector may also comprise a metallic conductor as defined above, wherein the metallic conductor is applied to a substrate, such as a polymer substrate. The substrate may take the form of a polymer such as polyethylene terephthalate (PET). The current collector may have a thickness of between 5 μm and 40 μm, preferably between 10 μm and 25 μm, for example between 15 μm and 20 μm.

A coating on the surface of the anode may be included. At least one or more coating layers may be envisaged. This coating may form an anode protection layer. Such anode coating layer may have beneficial effects on cell performance, for example by reducing inhomogeneous stripping and plating of the alkali metal present in the anode, which may reduce cracks or voids in the anode surface and may provide improvements in cycling and capacity life.

In accordance with the present invention, there is provided an electrochemical cell comprising a cathode as described herein. Preferably, the cell is a lithium-sulfur cell. In another embodiment, the cell is a sodium-sulfur cell. The cell in accordance with the present invention may be produced by any suitable method. For example, a separator may be placed on the cathode and the anode placed on the separator, forming a stack, followed by addition of the electrolyte to form the cell.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A carbon-sulfur composite material comprising:
(i) composite particles comprising electrochemically active sulfur material and an electronically conductive carbon material; and
(ii) a layer comprising a ceramic, a polymer, a ceramic-polymer hybrid material, or combinations thereof, wherein the layer covers the exterior surface of each of the particles.

2. The carbon-sulfur composite material of claim 1 wherein the composite particles further comprise a solid electrolyte material.

3. The carbon-sulfur composite material of claim 2, wherein the solid electrolyte material is selected from LiPON, LLZO, LATP, LGPS, LPS and LAGP and combinations thereof.

4. The carbon-sulfur composite material of claim 1, wherein the ceramic coating layer is selected from an oxide ceramic, a non-oxide ceramic such as a ceramic hydride, carbide, nitride, silicide, or combinations thereof.

5. The carbon-sulfur composite material of claim 4, wherein the ceramic coating layer is selected from aluminium oxide, titanium oxide, silicon oxide, vanadium oxide, zinc oxide, magnesium oxide, zirconium oxide, boron oxide, yttrium oxide, silicon nitride, aluminium nitride, boron nitride, and combinations thereof.

6. The carbon-sulfur composite material of claim 1, wherein the ceramic-polymer hybrid material is a metalcone.

7. The carbon-sulfur composite material of claim 6, wherein the metalcone is selected from alucone, titanicone, zircone, zincone or combinations thereof.

8. The carbon-sulfur composite material of claim 1, wherein the layer has a thickness of less than 100 nm, for example less than 50 nm.

9. The carbon-sulfur composite material of claim 1, wherein the composite material comprises greater than 60 weight % sulfur based on the total weight of the composite particles, for example greater than 65 weight % sulfur.

10. The carbon-sulfur composite material of claim 1, wherein the electronically conductive carbon material has an average pore volume of 1.5-10 cm3 g-1 and an average pore diameter of less than 10 nm, for example an average pore volume of 1.5-2 cm3 g-1 and an average pore diameter of 1 nm to 3 nm.

11. The carbon-sulfur composite material of claim 1, wherein the composite material is formed by melt infusion of sulfur into an activated carbon, wherein the activated carbon is optionally produced via a thermal KOH activation process.

12. The carbon-sulfur composite material of claim 1, wherein the area specific lithium ionic resistance of the coating layer is less than 1O O·cm2.

13. A cathode comprising a carbon-sulfur composite as claimed in claim 1.

14. A lithium-sulfur cell comprising a cathode as claimed in claim 13, wherein the cell further comprises an anode formed from lithium metal and/or a lithium metal alloy and an electrolyte.

15. The lithium-sulfur cell of claim 14 wherein the electrolyte is a liquid electrolyte; of example wherein the electrolyte comprises lithium bis(fluorosulfonyl)imide (LiFSI).

16. The lithium-sulfur cell of claim 14 wherein the electrolyte is a liquid electrolyte; for example wherein the electrolyte comprises carbonate based solvents such as fluoroethylene carbonate (FEC), vinylene carbonate (VC), dimethyl carbonate (DMC), or ethylene carbonate (EC).

17. The lithium-sulfur cell of claim 14 wherein the electrolyte is a solid electrolyte.

18. A method of forming a carbon-sulfur composite material in accordance with claim 1, wherein the coating layer is applied using atomic layer deposition or molecular layer deposition or CVD or PE-CVD or sol gel coating or hydrothermal precipitation or solvothermal precipitation; or a combination thereof.

19. The method of claim 18 wherein the coating layer is applied using atomic layer deposition, and wherein the atomic layer deposition is preferably conducted below 250° C.
